(19) United States
(12) Patent Application Publication
(10) Pub. No.: US 2024/0014563 A1
(43) Pub. Date: Jan. 11, 2024

(54) ANTENNA STRUCTURE AND COMMUNICATION DEVICE

(71) Applicant: Wistron NeWeb Corp., Hsinchu (TW)

(72) Inventors: Kuo-Jen LAI, Hsinchu (TW); Kuang-Yuan KU, Hsinchu (TW); Chun-Jui PAN, Hsinchu (TW)

(21) Appl. No.: 18/336,297

(22) Filed: Jun. 16, 2023

(30) Foreign Application Priority Data
Jul. 6, 2022 (TW) 111125238

(51) Int. Cl. H01Q 9/04; H01Q 1/48; H01Q 21/00

(52) U.S. Cl. CPC H01Q 9/045; H01Q 1/48; H01Q 21/00

(57) ABSTRACT

An antenna structure includes a dielectric substrate, a conductive frame, a first radiation element, and a second radiation element. The dielectric substrate has a first surface and a second surface which are opposite to each other. The conductive frame is disposed on the first surface of the dielectric substrate. The conductive frame has a slot region. The first radiation element is disposed on the second surface of the dielectric substrate, and is coupled to a feeding point. The second radiation element is disposed on the first surface of the dielectric substrate, and is coupled to the conductive frame. The second radiation element is adjacent to the first radiation element. The first radiation element is partially adjacent to the second radiation element on one side. The first radiation element and the second radiation element are substantially positioned inside the slot region of the conductive frame.

### CROSS REFERENCE TO RELATED APPLICATIONS

This application claims priority of Taiwan Patent Application No. 111125238 filed on Jul. 6, 2022, the entirety of which is incorporated by reference herein.

### BACKGROUND OF THE INVENTION

### Field of the Invention

The disclosure generally relates to an antenna structure, and more particularly, to an antenna structure with an almost omnidirectional radiation pattern.

### Description of the Related Art

With the advancements being made in mobile communication technology, mobile devices such as portable computers, mobile phones, multimedia players, and other hybrid functional portable electronic devices have become more common. To satisfy consumer demand, mobile devices can usually perform wireless communication functions. Some devices cover a large wireless communication area; these include mobile phones using 2G, 3G, and LTE (Long Term Evolution) systems and using frequency bands of 700 MHz, 850 MHz, 900 MHz, 1800 MHz, 1900 MHz, 2100 MHz, 2300 MHz, and 2500 MHz. Some devices cover a small wireless communication area; these include mobile phones using Wi-Fi systems and using frequency bands of 2.4 GHz, 5.2 GHz, and 5.8 GHz.

Antennas are indispensable elements for wireless communication. If the directivity of an antenna being used for signal reception and transmission is too high, it will degrade the communication quality of the related mobile device. Accordingly, it has become a critical challenge for antenna designers to design an antenna element that is omnidirectional yet small in size.

### BRIEF SUMMARY OF THE INVENTION

In an exemplary embodiment, the invention is directed to an antenna structure that includes a dielectric substrate, a conductive frame, a first radiation element, and a second radiation element. The dielectric substrate has a first surface and a second surface which are opposite to each other. The conductive frame is disposed on the first surface of the dielectric substrate. The conductive frame has a slot region. The first radiation element is disposed on the second surface of the dielectric substrate, and is coupled to a feeding point. The second radiation element is disposed on the first surface of the dielectric substrate, and is coupled to the conductive frame. The second radiation element is adjacent to the first radiation element. The first radiation element is partially adjacent to the second radiation element on one side. The first radiation element and the second radiation element are substantially positioned inside the slot region of the conductive frame.

In another exemplary embodiment, the invention is directed to a communication device that includes a plurality of antenna structures as mentioned above, an RF (Radio Frequency) module, and a system ground plane. The antenna structures are excited by the RF module. The system ground plane is coupled to the antenna structures. The system ground plane is disposed between the antenna structures.

### BRIEF DESCRIPTION OF DRAWINGS

The invention can be more fully understood by reading the subsequent detailed description and examples with references made to the accompanying drawings, wherein:

FIG. 1A is a front view of an antenna structure according to an embodiment of the invention;

FIG. 1B is a back view of an antenna structure according to an embodiment of the invention;

FIG. 1C is a see-through view of an antenna structure according to an embodiment of the invention;

FIG. 2 is a diagram of return loss of an antenna structure according to an embodiment of the invention;

FIG. 3A is a front view of an antenna structure according to an embodiment of the invention;

FIG. 3B is a back view of an antenna structure according to an embodiment of the invention;

FIG. 4A is a radiation pattern of an antenna structure without a ground plane according to an embodiment of the invention;

FIG. 4B is a radiation pattern of an antenna structure with a ground plane according to an embodiment of the invention; and

FIG. 5 is a perspective view of a communication device according to an embodiment of the invention.

### DETAILED DESCRIPTION OF THE INVENTION

In order to illustrate the purposes, features and advantages of the invention, the embodiments and figures of the invention are shown in detail as follows.

Certain terms are used throughout the description and following claims to refer to particular components. As one skilled in the art will appreciate, manufacturers may refer to a component by different names. This document does not intend to distinguish between components that differ in name but not function. In the following description and in the claims, the terms “include” and “comprise” are used in an open-ended fashion, and thus should be interpreted to mean “include, but not limited to . . . ”. The term “substantially” means the value is within an acceptable error range. One skilled in the art can solve the technical problem within a predetermined error range and achieve the proposed technical performance. Also, the term “couple” is intended to mean either an indirect or direct electrical connection. Accordingly, if one device is coupled to another device, that connection may be through a direct electrical connection, or through an indirect electrical connection via other devices and connections.

The following disclosure provides many different embodiments, or examples, for implementing different features of the provided subject matter. Specific examples of components and arrangements are described below to simplify the present disclosure. These are, of course, merely examples and are not intended to be limiting. For example, the formation of a first feature over or on a second feature in the description that follows may include embodiments in which the first and second features are formed in direct contact, and may also include embodiments in which additional features may be formed between the first and second features, such that the first and second features may not be in direct contact. In addition, the present disclosure may repeat reference numerals and/or letters in the various examples. This repetition is for the purpose of simplicity and clarity and does not in itself dictate a relationship between the various embodiments and/or configurations discussed.

Furthermore, spatially relative terms, such as “beneath,” “below,” “lower,” “above,” “upper” and the like, may be used herein for ease of description to describe one element or feature's relationship to another element(s) or feature(s) as illustrated in the figures. The spatially relative terms are intended to encompass different orientations of the device in use or operation in addition to the orientation depicted in the figures. The apparatus may be otherwise oriented (rotated 90 degrees or at other orientations) and the spatially relative descriptors used herein may likewise be interpreted accordingly.

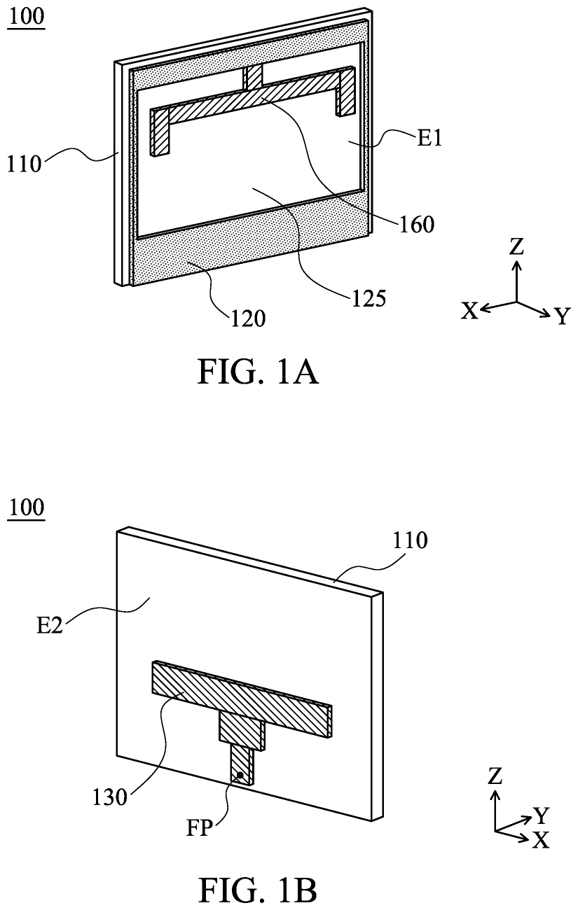

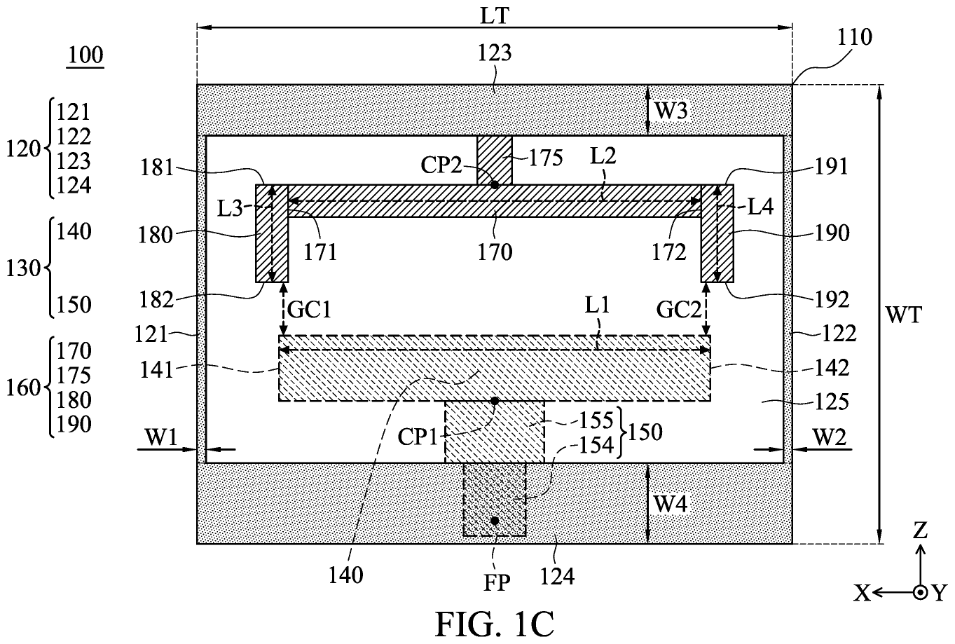

FIG. 1A is a front view of an antenna structure 100 according to an embodiment of the invention. FIG. 1B is a back view of the antenna structure 100 according to an embodiment of the invention. FIG. 1C is a see-through view of the antenna structure 100 according to an embodiment of the invention. Please refer to FIG. 1A, FIG. 1B, and FIG. 1C together. The antenna structure 100 may be applied to a vehicle device or a mobile device, such as a smart phone, a tablet computer, or a notebook computer. In the embodiment of FIG. 1A, FIG. 1B, and FIG. 1C, the antenna structure 100 at least includes a dielectric substrate 110, a conductive frame 120, a first radiation element 130, and a second radiation element 160. The conductive frame 120, the first radiation element 130, and the second radiation element 160 may all be made of metal materials, such as copper, silver, aluminum, iron, or their alloys.

The dielectric substrate 110 may be an FR4 (Flame Retardant 4) substrate, a PCB (Printed Circuit Board), or an FPC (Flexible Printed Circuit). The dielectric substrate 110 has a first surface E1 and a second surface E2 which are opposite to each other. The conductive frame 120 and the second radiation element 160 are disposed on the first surface E1 of the dielectric substrate 110. The first radiation element 130 is disposed on the second surface E2 of the dielectric substrate 110.

The conductive frame 120 has a slot region 125. For example, the conductive frame 120 may substantially have a hollow rectangular shape, and the slot region 125 of the conductive frame 120 may substantially have a rectangular shape, but they are not limited thereto. It should be noted that the first radiation element 130 and the second radiation element 160 (or their vertical projections) are substantially positioned inside the slot region 125 of the conductive frame 120. In some embodiments, the conductive frame 120 includes a first narrow portion 121, a second narrow portion 122, a first wide portion 123, and a second wide portion 124. The second narrow portion 122 is opposite to the first narrow portion 121. The second wide portion 124 is opposite to the first wide portion 123. The aforementioned slot region 125 is surrounded by the first narrow portion 121, the second narrow portion 122, the first wide portion 123, and the second wide portion 124 of the conductive frame 120.

The first radiation element 130 includes a first main branch 140 and a feeding branch 150. The first main branch 140 may substantially have a straight-line shape. The first main branch 140 has a first end 141 and a second end 142, which may be two open ends. The first central point CP1 on the first main branch 140 is coupled through the feeding branch 150 to a feeding point FP. The feeding point FP may be further coupled to a signal source (not shown). For example, the aforementioned signal source may be an RF (Radio Frequency) module for exciting the antenna structure 100. In some embodiments, the feeding branch 150 includes a narrow portion 154 and a wide portion 155. The narrow portion 154 is coupled to the feeding point FP, and the wide portion 155 is coupled to the first central point CP1, so as to fine-tune the feeding impedance of the antenna structure 100. However, the invention is not limited thereto. In alternative embodiments, the feeding branch 150 is modified to an equal-width straight-line shape. In some embodiments, the first radiation element 130 may substantially have a T-shape.

The second radiation element 160 is adjacent to the first radiation element 130. The first radiation element 130 is partially adjacent to the second radiation element 160 on one side. It should be noted that the term “adjacent” or “close” over the disclosure means that the distance (spacing) between two corresponding elements is smaller than a predetermined distance (e.g., 10 mm or the shorter), but often does not mean that the two corresponding elements directly touch each other (i.e., the aforementioned distance/spacing between them is reduced to 0). Specifically, the second radiation element 160 includes a second main branch 170, a connection branch 175, a first extension branch 180, and a second extension branch 190. In some embodiments, the second radiation element 160 may substantially have an inverted Y-shape.

The second main branch 170 may substantially have another straight-line shape, which is substantially parallel to the first main branch 140. The second main branch 170 has a first end 171 and a second end 172. The second central point CP2 on the second main branch 170 is coupled through the connection branch 175 to the first wide portion 123 of the conductive frame 120. The first extension branch 180 may substantially have a relatively short straight-line shape. The first extension branch 180 has a first end 181 and a second end 182. The first end 181 of the first extension branch 180 is coupled to the first end 171 of the second main branch 170. The second end 182 of the first extension branch 180 is an open end, which extends toward the first main branch 140. The second extension branch 190 may substantially have another relatively short straight-line shape, which may be substantially parallel to the first extension branch 180. The second extension branch 190 has a first end 191 and a second end 192. The first end 191 of the second extension branch 190 is coupled to the second end 172 of the second main branch 170. The second end 192 of the second extension branch 190 is an open end, which extends toward the first main branch 140. In some embodiments, a first coupling gap GC1 is formed between the second end 182 of the first extension branch 180 and the first end 141 of the first main branch 140. Also, a second coupling gap GC2 is formed between the second end 192 of the second extension branch 190 and the second end 142 of the first main branch 140.

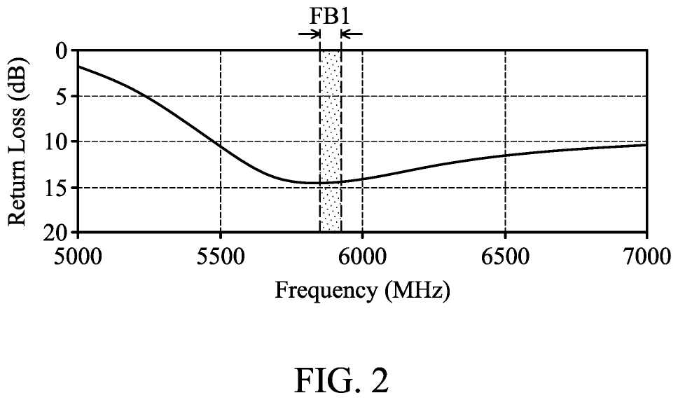

FIG. 2 is a diagram of return loss of the antenna structure 100 according to an embodiment of the invention. The horizontal axis represents the operational frequency (MHz), and the vertical axis represents the return loss (dB). According to the measurement of FIG. 2, the antenna structure 100 can cover an operational frequency band FB1. The operational frequency band FB1 may be from 5850 MHz to 5925 MHz. Therefore, the antenna structure 100 can support at least the wideband operations of vehicle-to-everything (V2X) or WLAN (Wireless Local Area Network) 5 GHz. It should be noted that since the first radiation element 130 and the second radiation element 160 are both surrounded by the conductive frame 120, the whole size of the antenna structure 100 is significantly reduced.

In some embodiments, the operational principles of the antenna structure 100 will be described as follows. The second main branch 170 of the second radiation element 160 is mainly excited to generate the aforementioned operational frequency band FB1. The first main branch 140 of the first radiation element 130 is configured to control the high-frequency shift or the low-frequency shift of the aforementioned operational frequency band FB1. In the conductive frame 120, if the width W1 of the first narrow portion 121 and the width W2 of the second narrow portion 122 become larger, the radiation gain of the antenna structure 100 can be increased. Conversely, if the width W1 of the first narrow portion 121 and the width W2 of the second narrow portion 122 become smaller, the omnidirectional characteristics of the antenna structure 100 can be improved.

In some embodiments, the element sizes of the antenna structure 100 will be described as follows. In the conductive frame 120, the width W1 of the first narrow portion 121 may be from 0.25 mm to 0.5 mm, the width W2 of the second narrow portion 122 may be from 0.25 mm to 0.5 mm, the width W3 of the first wide portion 123 may be from 1.5 mm to 2.5 mm, and the width W4 of the second wide portion 124 may be from 2.5 mm to 3.5 mm. In addition, the total length LT of the conductive frame 120 may be about 19.5 mm, and the total width WT of the conductive frame 120 may be about 14.5 mm. The length L1 of the first main branch 140 of the first radiation element 130 may be from 0.25 to 0.5 wavelength (λ/4˜λ/2) of the operational frequency band FB1 of the antenna structure 100. The length L2 of the second main branch 170 of the second radiation element 160 may be substantially equal to wavelength (λ/4) of the operational frequency band FB1 of the antenna structure 100. The length L3 of the first extension branch 180 of the second radiation element 160 may be from 1.5 mm to 2.5 mm. The length L4 of the second extension branch 190 of the second radiation element 160 may be from 1.5 mm to 2.5 mm. The width of the first coupling gap GC1 may be from 0.5 mm to 2 mm. The width of the second coupling gap GC2 may be from 0.5 mm to 2 mm. The above ranges of element sizes are calculated and obtained according to many experiment results, and they help to optimize the radiation gain and the omnidirectional characteristics of the antenna structure 100.

The following embodiments will introduce different configurations and applications of the antenna structure 100. It should be understood that these figures and descriptions are merely exemplary, rather than limitations of the invention.

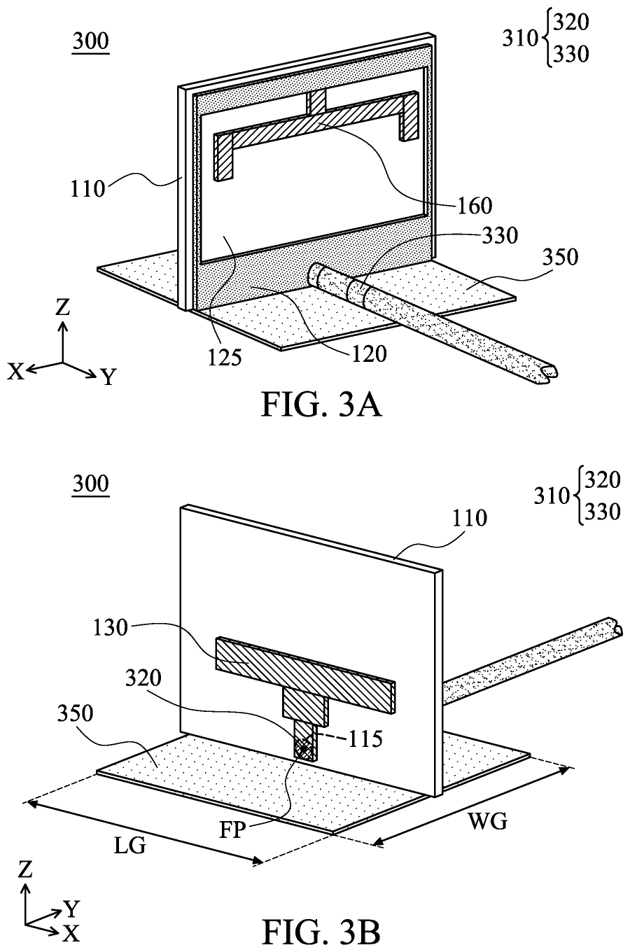

FIG. 3A is a front view of an antenna structure 300 according to an embodiment of the invention. FIG. 3B is a back view of the antenna structure 300 according to an embodiment of the invention. Please refer to FIG. 3A and FIG. 3B together. FIG. 3A and FIG. 3B are similar to FIG. 1A, FIG. 1B, and FIG. 1C. In the embodiment of FIG. 3A and FIG. 3B, the antenna structure 300 further includes a cable 310 and a ground plane 350, which may be made of metal materials. For example, the cable 310 may be a coaxial cable coupled to the aforementioned signal source. In addition, the dielectric substrate 110 may further have a via hole 115. The cable 310 includes a central conductive line 320 and an outer conductor 330. The outer conductor 330 of the cable 320 is respectively coupled to the conductive frame 120 and the ground plane 350. The central conductive line 320 of the cable 310 passes through the via hole 115 of the dielectric substrate 110, and is coupled to the feeding point FP and the first radiation element 130, so as to excite the antenna structure 300. In some embodiments, the central conductive line 320 of the cable 310 is not electrically connected to the conductive frame 120. The ground plane 350 is disposed below the dielectric substrate 110. The ground plane 350 may be substantially perpendicular to the dielectric substrate 110. In some embodiments, the conductive frame 120 does not directly touch the ground plane 350. It should be noted that the antenna structure 300 provides an almost omnidirectional radiation pattern, and the ground plane 350 is configured to prevent the cable 310 from negatively affecting the radiation pattern. In some embodiments, the length LG of the ground plane 350 is longer than or equal to 19.5 mm, and the width WG of the ground plane 350 is longer than or equal to 9 mm. Other features of the antenna structure 300 of FIG. 3A and FIG. 3B are similar to those of the antenna structure 100 of FIG. 1A, FIG. 1B, and FIG. 1C. Accordingly, the two embodiments can achieve similar levels of performance.

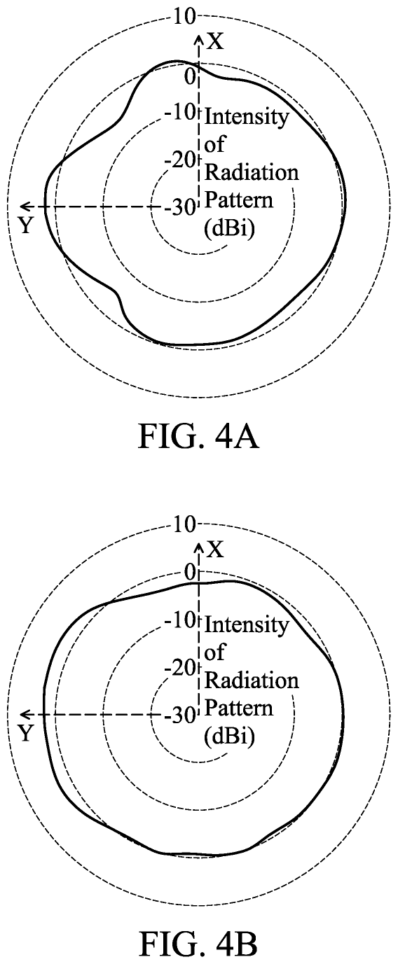

FIG. 4A is a radiation pattern of the antenna structure 300 without the ground plane 350 according to an embodiment of the invention (which may be measured along the XY-plane). According to the measurement of FIG. 4A, the incorporation of the cable 310 may change the radiation pattern of the antenna structure 300, such that the radiation pattern may have non-ideal nulls.

FIG. 4B is a radiation pattern of the antenna structure 300 with the ground plane 350 according to an embodiment of the invention (which may be measured along the XY-plane). According to the measurement of FIG. 4B, if the cable 310 and the ground plane 350 coupled thereto are both used, the non-ideal effect of the cable 310 can be almost cancelled, such that the antenna structure 300 can still provide an almost omnidirectional radiation pattern.

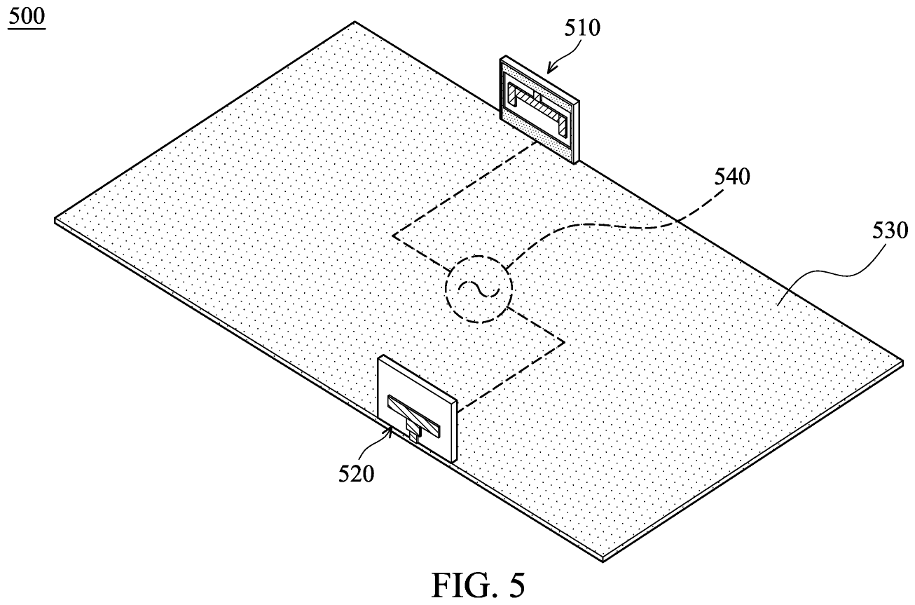

FIG. 5 is a perspective view of a communication device 500 according to an embodiment of the invention. For example, the communication device 500 may be a vehicle device or a mobile device, but it is not limited thereto. In the embodiment of FIG. 5, the communication device 500 includes a plurality of antenna structures 510 and 520, a system ground plane 530, and an RF module 540. The antenna structures 510 and 520 can be excited by the RF module 540. The detailed features of the antenna structures 510 and 520 have been described in the previous embodiments, and they will not be illustrated again herein. The number of antenna structures 510 and 520 is not limited in the invention. In alternative embodiments, the communication device 500 includes more antenna structures (not shown). The system ground plane 530 is coupled to the antenna structures 510 and 520. In addition, the system ground plane 530 is disposed between the antenna structures 510 and 520, and it is used as an integral ground plane of the antenna structures 510 and 520. With such a design, the communication device 500 can support the MIMO (Multi-Input and Multi-Output) function.

The invention proposes a novel antenna structure and a novel communication device. In comparison to the conventional design, the invention has at least the advantages of omnidirectional characteristics, high gain, small size, wide bandwidth, and low manufacturing cost. Therefore, the invention is suitable for application in a variety of communication systems.

Note that the above element sizes, element shapes, and frequency ranges are not limitations of the invention. An antenna designer can fine-tune these settings or values according to different requirements. It should be understood that the antenna structure and the communication device of the invention are not limited to the configurations of FIGS. 1-5. The invention may merely include any one or more features of any one or more embodiments of FIGS. 1-5. In other words, not all of the features displayed in the figures should be implemented in the antenna structure and the communication device of the invention.

Use of ordinal terms such as “first”, “second”, “third”, etc., in the claims to modify a claim element does not by itself connote any priority, precedence, or order of one claim element over another or the temporal order in which acts of a method are performed, but are used merely as labels to distinguish one claim element having a certain name from another element having the same name (but for use of the ordinal term) to distinguish the claim elements.

While the invention has been described by way of example and in terms of the preferred embodiments, it should be understood that the invention is not limited to the disclosed embodiments. On the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. An antenna structure, comprising:
a dielectric substrate, having a first surface and a second surface opposite to each other;
a conductive frame, disposed on the first surface of the dielectric substrate, wherein the conductive frame has a slot region;
a first radiation element, disposed on the second surface of the dielectric substrate, and coupled to a feeding point; and
a second radiation element, disposed on the first surface of the dielectric substrate, and coupled to the conductive frame, wherein the second radiation element is adjacent to the first radiation element, and the first radiation element is partially adjacent to the second radiation element on one side;
wherein the first radiation element and the second radiation element are substantially positioned inside the slot region of the conductive frame.

2. The antenna structure as claimed in claim 1, further comprising:
a cable, comprising a central conductive line and an outer conductor, wherein the outer conductor of the cable is coupled to the conductive frame.

3. The antenna structure as claimed in claim 2, wherein the dielectric substrate further has a via hole, and the central conductive line of the cable passes through the via hole and is coupled to the feeding point.

4. The antenna structure as claimed in claim 2, further comprising:
a ground plane, disposed below the dielectric substrate, wherein the outer conductor of the cable is further coupled to the ground plane.

5. The antenna structure as claimed in claim 4, wherein the ground plane is substantially perpendicular to the dielectric substrate.

6. The antenna structure as claimed in claim 4, wherein the antenna structure provides an almost omnidirectional radiation pattern, and the ground plane is configured to prevent the cable from negatively affecting the radiation pattern.

7. The antenna structure as claimed in claim 1, wherein the conductive frame substantially has a hollow rectangular shape.

8. The antenna structure as claimed in claim 1, wherein the slot region of the conductive frame substantially has a rectangular shape.

9. The antenna structure as claimed in claim 1, wherein the first radiation element substantially has a T-shape.

10. The antenna structure as claimed in claim 1, wherein the second radiation element substantially has an inverted Y-shape.

11. The antenna structure as claimed in claim 1, wherein the antenna structure covers an operational frequency band.

12. The antenna structure as claimed in claim 11, wherein the first radiation element comprises:
a first main branch; and
a feeding branch, wherein a first central point on the first main branch is coupled through the feeding branch to the feeding point.

13. The antenna structure as claimed in claim 12, wherein a length of the first main branch is from 0.25 to 0.5 wavelength of the operational frequency band.

14. The antenna structure as claimed in claim 12, wherein the second radiation element comprises:
a second main branch, having a first end and a second end;
a connection branch, wherein a second central point on the second main branch is coupled through the connection branch to the conductive frame;
a first extension branch, coupled to the first end of the second main branch; and
a second extension branch, coupled to the second end of the second main branch.

15. The antenna structure as claimed in claim 14, wherein a length of the second main branch is substantially equal to 0.25 wavelength of the operational frequency band.

16. The antenna structure as claimed in claim 14, wherein a first coupling gap is formed between the first extension branch and the first main branch, and a second coupling gap is formed between the second extension branch and the first main branch.

17. The antenna structure as claimed in claim 16, wherein a width of each of the first coupling gap and the second coupling gap is from 0.5 mm to 2 mm.

18. The antenna structure as claimed in claim 1, wherein the conductive frame comprises a first narrow portion and a second narrow portion opposite to each other, and further comprises a first wide portion and a second wide portion opposite to each other.

19. The antenna structure as claimed in claim 18, wherein a width of each of the first narrow portion and the second narrow portion of the conductive frame is from to 0.5 mm.

20. A communication device, comprising:
a plurality of antenna structures as claimed in claim 1;
an RF (Radio Frequency) module, wherein the antenna structures are excited by the RF module; and
a system ground plane, coupled to the antenna structures, wherein the system ground plane is disposed between the antenna structures.
